(19) United States
(12) Patent Application Publication
(10) Pub. No.: US 2005/0110910 A1
(43) Pub. Date: May 26, 2005

(54) Method and apparatus for selecting digital broadcasting channel

(75) Inventor: Young-kee Kim, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/849,213

(22) Filed: May 20, 2004

(30) Foreign Application Priority Data
Nov. 21, 2003 (KR) 2003-82852

(51) Int. Cl. H04N 5/44

(52) U.S. Cl. 348/734

(57) ABSTRACT

Disclosed is a remote controller apparatus with easy digital broadcasting channel selection. The remote controller apparatus includes a key input section including menu key, directional key, and digit key for remotely controlling an image display device; and a digital broadcasting channel selection key for being inputted prior to the digit key to select the digital broadcasting channel. In accordance with the remote controller apparatus, there is not a wide difference between the operation times of the key included in the remote controller apparatus and the operation times for selecting the analogue broadcasting channel, and since it is possible to select the digital broadcasting channel by pressing the digital broadcasting selection key and then selectively pressing the digit key included in the key matrix only when selecting the digital broadcasting channel, it is easy to select the analogue broadcasting channel and the digital broadcasting channel.

This application claims benefit under 35 U.S.C. § 119 from Korean Patent Application No. 2003-82852, filed on Nov. 21, 2003, the entire content of which is incorporated herein by reference.

### BACKGROUND OF THE INVENTION

1. Field of the Invention

The present invention relates generally to a remote controller apparatus and a method for selecting digital broadcasting channels by the remote controller apparatus, and more particularly, a remote controller apparatus and a channel selection method in which the channel selection of digital broadcasting and analogue broadcasting is simple in an image display device capable of receiving the digital broadcasting and the analogue broadcasting.

2. Description of the Related Art

Digital broadcasting increasingly substitutes for analogue broadcasting. The digital broadcasting can provide a high image quality and implement various sound effects, as compared to the analogue broadcasting. On the other hand, even though the digital broadcasting substitutes for the analogue broadcasting, since the receiver receiving the existing analogue broadcasting are already widely used, the current digital broadcasting receiver is adapted to receive both the digital broadcasting and the analogue broadcasting. According to this, the remote controller apparatus for remotely controlling the digital broadcasting receiver is also provided with functions to select the digital broadcasting or the analogue broadcasting and selectively receives the digital broadcasting and the analogue broadcasting by various methods.

FIG. 1 is a schematic showing a conventional remote controller apparatus for receiving digital broadcasting.

The shown remote controller apparatus comprises a key matrix 10, a volume adjusting key 11, and a channel setting key 12. The key matrix 10 includes digit keys of 0 to 9 and a menu key, and can set channels in a digital broadcasting receiver by the viewer's direct press of the digital keys. The volume adjusting key 11 adjusts the volume of an audio signal, which is outputted from the digital broadcasting receiver, and the channel setting key 12 performs up-down operations on the broadcasting channel that the viewer is watching. When the viewer selects the digit key included in the remote controller apparatus to supply channel information to the digital broadcasting receiver, the digital broadcasting receiver first detects the presence or absence of the digital broadcasting corresponding to the channel information supplied from the remote controller apparatus. As a result of the detection, if the digital broadcasting is absent, the digital broadcasting receiver stands ready to receive the analogue broadcasting. On the other hand, the viewer may transmit the channel information via the digital broadcasting or the analogue broadcasting to the digital broadcasting receiver by comparing the channel information that is previously stored on the remote controller apparatus by the viewer with the channel that the viewer inputs through the digit keys. According to the above methods, it takes the viewer a considerable time to watch the digital broadcasting or the analogue broadcasting corresponding to the channel number selected by the digit keys.

FIG. 2 is a schematic view showing another type of conventional remote controller apparatus for receiving digital broadcasting.

The remote controller apparatus shown in FIG. 2 is similar to that shown in FIG. 1 except that it further comprises a mode switch key 21 for switching the digital broadcasting channel and the analogue broadcasting channel. The mode switch key 21 allows the viewer to watch the digital broadcasting by the digital broadcasting receiver when the viewer presses the mode switch key 21 while he/she is watching the analogue broadcasting.

Similarly, when the viewer presses the mode switch key 21 while he/she is watching the digital broadcasting, the mode switch key 21 transmits a prescribed control signal to the digital broadcasting receiver so that the analogue broadcasting corresponding to the digital broadcasting which the viewer is watching may be received by the digital broadcasting receiver.

The remote controller apparatus shown in FIG. 2 may seem to be convenient in that the digital broadcasting and the analogue broadcasting are switched, but when the digital broadcasting is selected by the mode switch key 21, the channel numbers selected by the viewer through the press of the digit keys of the key matrix 20 or the channel setting key 24 are recognized as channel numbers on the digital broadcasting and then applied to the digital broadcasting receiver. Similarly, when the analogue broadcasting is selected by the mode switch key 21, the channel numbers selected by the viewer through the press of the digit keys of the key matrix 20 or the channel setting key 24 are recognized as channel numbers on the analogue broadcasting and then applied to the digital broadcasting receiver. According to this, the viewer can select a desired channel only when the viewer always recognizes that the broadcasting channel he is watching is the digital broadcasting or the analogue broadcasting.

FIG. 3 is a schematic view showing yet another type of conventional remote controller apparatus for receiving digital broadcasting.

The remote controller apparatus shown in FIG. 3 is similar to that shown in FIG. 1 except that it further comprises a—key 31.

The—key 31 is a symbol used to select the digital broadcasting, and is displaced between analogue channel numbers and digital identifier. For example, in the case of KBS broadcasting in Korea the analogue broadcasting channel being number “09”, the channel number is to be inputted in the form of 09-1. That is, by adding “-” symbol between the channel number “09” and the digital identifier “1”, the analogue broadcasting and the digital broadcasting are differentiated. However, such a channel selection method has problems that the viewer performs a number of operations to select the digital broadcasting, and that the viewer who is used to selecting the existing analogue broadcasting channel is not accustomed to such a broadcasting channel selection method.

### SUMMARY OF THE INVENTION

The present invention has been developed in order to solve the above drawbacks and other problems associated with the conventional arrangement. The aspect of the present invention is to provide a remote controller apparatus in which the operation times of the key included in the remote controller apparatus can be minimized, and the viewer who is used to the existing analogue broadcasting channel selection method can easily select the analogue broadcasting channel or the digital broadcasting channel, and a channel selection method by the remote controller apparatus.

The foregoing and other aspects and advantages are substantially realized by providing a remote controller apparatus comprising a key input section including menu key, directional key, and digit key for remotely controlling an image display device; and a digital broadcasting channel selection key for being inputted prior to the digit key to select a digital broadcasting channel.

In an exemplary embodiment, the number of the digital broadcasting channel is selected when selecting the digital broadcasting channel selection key and the digit key in order.

In another exemplary embodiment, after selecting the digital broadcasting channel selection key, the digital broadcasting channel is selected when an analogue channel number corresponding to the digital broadcasting channel is inputted through the digit key.

The analogue channel number may be selected by the digit key corresponding to the analogue channel number.

The foregoing and other objects and advantages are substantially realized by steps of selecting digital broadcasting channel selection key; and selecting digit key after the digital broadcasting channel selection key is selected.

The number of the digital broadcasting channel may be selected when selecting the digital broadcasting channel selection key and the digit key in order.

In an exemplary embodiment, after selecting the digital broadcasting channel selection key, the digital broadcasting channel is selected when analogue channel number corresponding to the digital broadcasting channel is inputted through the digit key.

The analogue channel number may be selected by the digit key corresponding to the analogue channel number.

### BRIEF DESCRIPTION OF THE DRAWINGS

The above aspects and features of the present invention will be more apparent by describing certain embodiments of the present invention with reference to the accompanying drawings, in which:

FIG. 1 is a schematic showing a conventional remote controller apparatus for receiving digital broadcasting.

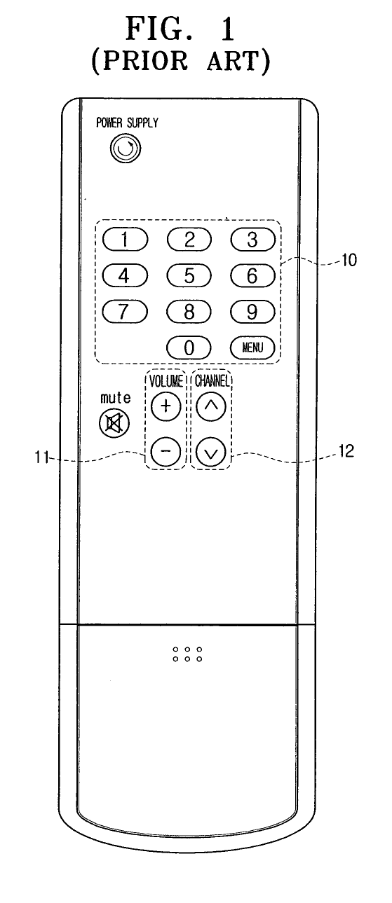

FIG. 2 is a schematic showing another conventional remote controller apparatus for receiving digital broadcasting.

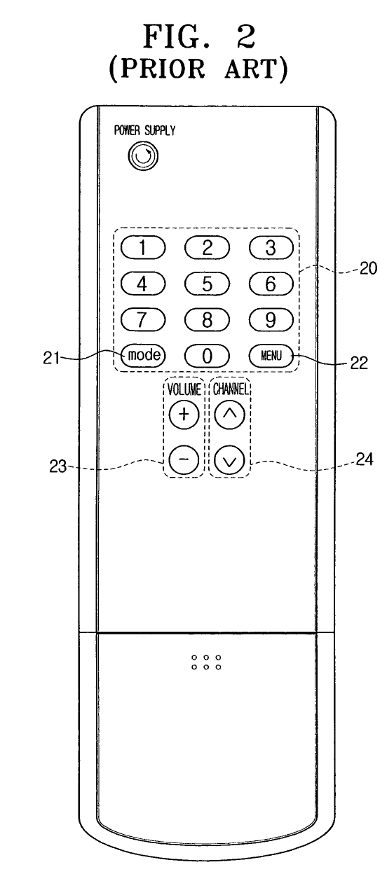

FIG. 3 is a schematic showing yet another conventional remote controller apparatus for receiving digital broadcasting.

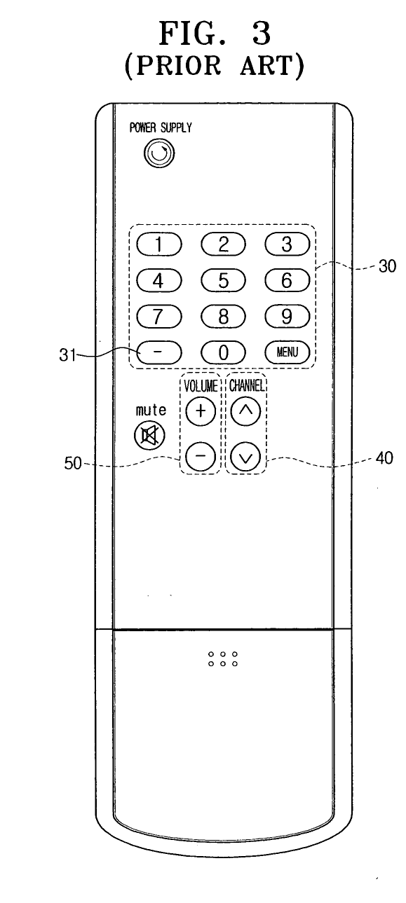

FIG. 4 is a schematic showing a remote controller apparatus for receiving digital broadcasting according to the present invention.

FIG. 5 is a flow chart explaining an embodiment of digital broadcasting channel selection method by the remote controller apparatus according to the present invention

### DETAILED DESCRIPTION OF THE ILLUSTRATIVE, NON-LIMITING EMBODIMENTS

Certain embodiments of the present invention will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

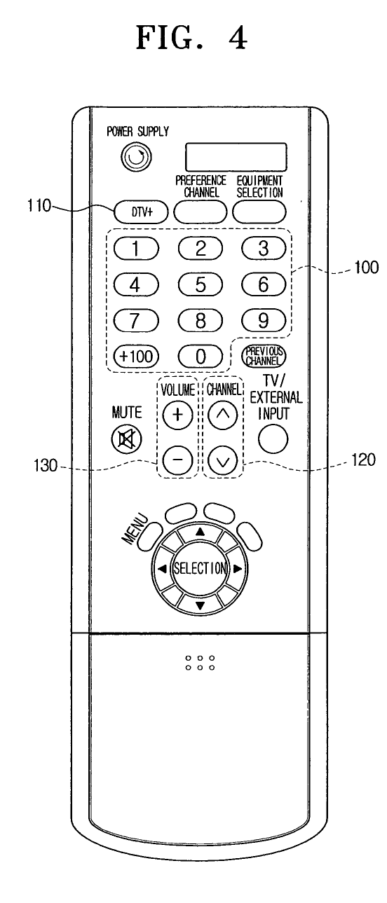

FIG. 4 is a schematic showing a remote controller apparatus for receiving digital broadcasting according to the present invention.

The shown remote controller apparatus comprises a key matrix 100, a digital broadcasting selection key (DTV+) 110, a channel setting key 120, and a volume adjusting key 130.

The key matrix 100 includes digit keys of 0 through 9, and is provided for the viewer directly transmitting channel number to the digital broadcasting receiver.

The digital broadcasting selection key (DTV+) 110 is provided so that when the key 110 is selected before the viewer presses the digit key included in the key matrix 100, the channel number selected by the digit key may be changed to digital broadcasting channel number. The volume adjusting key 130 is included to adjust the volume of the audio signal outputted from the digital broadcasting receiver, and the channel setting key 120 is included to perform up-down operations on the broadcasting channel that the viewer is watching. In addition, there are mute key for muting the audio signal outputted from the digital broadcasting receiver, menu key for calling OSD (On Screen Display) menu to the digital broadcasting receiver, and the like, but these keys are included in a common remote controller apparatus, and since their functions are well known, the description thereof will be omitted below.

When the digital broadcasting selection key (DTV+) 110 is selected and then the digit key is pressed, the channel number selected by the digit key is recognized as the digital broadcasting channel number in the remote controller apparatus. The remote controller apparatus incorporates a microcomputer (not shown) for generating channel number based on the selection of the digit key and applying the channel number to a transmitter (not shown).

When the viewer selects the digital broadcasting selection key (DTV+) 110, it is preferable that the microcomputer is programmed such that it recognizes as the digital broadcasting channel number the channel number based on the digit key inputted after the digital broadcasting selection key (DTV+) 110 is pressed.

Hereinafter, referring to Table 1 below, the description will be made of the procedures for setting the channel number of the remote controller apparatus based on the selection of the digital broadcasting selection key (DTV+) 110.

TABLE 1

| | Analogue broadcasting | Digital broadcasting |
|---|---|---|
| Broadcasting station | channel | channel |
| KBS | 09 | 15 |
| MBC | 11 | 14 |

As indicated in Table 1, in the case of the broadcasting station KBS, it is assigned number 09 for the existing analogue broadcasting channel, but the digital broadcasting channel corresponding to the analogue broadcasting channel is assigned with number 15. This is the reason why the analogue broadcasting channel and the digital broadcasting channel do not use the same frequency. And, a general viewer memorizes the analogue broadcasting channel number of the broadcasting station KBS, but tends not to memorize a separate digital broadcasting channel for selecting the digital broadcasting channel. Accordingly, in order to select the digital broadcasting channel of the broadcasting station KBS, the remote controller apparatus of the present invention is adapted to select the digital broadcasting channel (the channel number “15”) by pressing the digital broadcasting setting key (DTV+) 110 and then pressing the analogue broadcasting channel number 09. This is noticed that the viewer is used to selecting the existing analogue broadcasting channel. The viewer can select the channel by pressing the digit key when selecting the existing analogue broadcasting channel or can select the channel by pressing the channel setting key 120 in the same manner as the existing analogue broadcasting channel method. Accordingly, the viewer does not specially need to memorize the digital broadcasting channel because it is proper if the viewer presses the digital broadcasting selection key (DTV+) 110 and then presses the existing analogue broadcasting channel number (“09”) only when he wants to select the digital broadcasting channel. Such a channel mapping can be realized by a microcomputer that is generally incorporated in the remote controller apparatus.

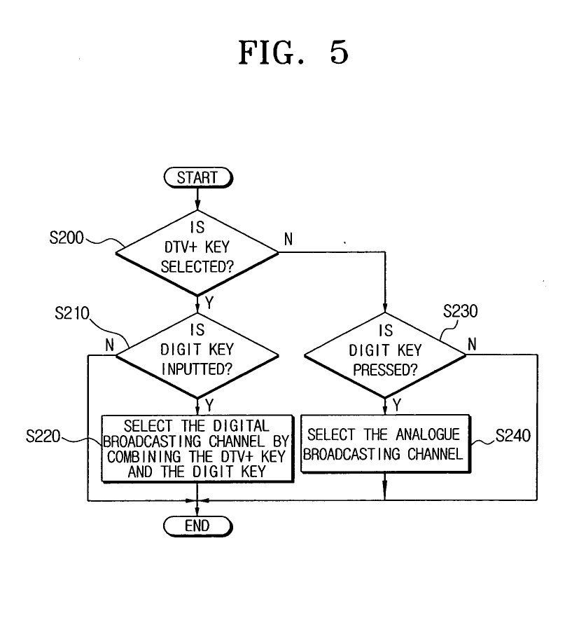

FIG. 5 is a flow chart showing an embodiment of the digital broadcasting channel selection method by the remote controller apparatus according to the present invention.

First of all, the microcomputer (not shown) incorporated in the remote controller apparatus determines if the viewer has selected the digital broadcasting selection key (DTV+) 110 (S200). As a result of the determination, if the digital broadcasting selection key (DTV+) 110 is pressed, the microcomputer determines whether the key matrix 100 has been inputted by the viewer (S210). As a result of the determination, if the digit key (0 to 9) has been inputted, the microcomputer changes the inputted digit key into the channel number corresponding to the digital broadcasting channel and supplies the changed channel to the digital broadcasting receiver through an infrared transmitter (not shown) (S220).

For example, if the viewer presses the digital broadcasting selection key (DTV+) 110 and then sequentially presses the digit key 0, 9, the digital broadcasting receiver is applied with the digital broadcasting channel number “15” corresponding to the analogue broadcasting channel number “09”. This is indicated in Table 1 above.

On the other hand, if the viewer presses the digit key included in the key matrix 100 without pressing the digital broadcasting selection key (DTV+) 110 (S230), the microcomputer recognizes the pressed digit key as one for selecting the analogue broadcasting channel. According to this, the viewer may still use the existing channel selection method when selecting the analogue broadcasting channel, and since the viewer may select the digital broadcasting channel by pressing the digital broadcasting selection key (DTV+) 110 and then selectively pressing the digit key included in the key matrix 100 only when selecting the digital broadcasting channel, the viewer does not need to memorize the digital broadcasting channel.

As described above, in accordance with the present invention, there is not a wide difference between the operation times of the key included in the remote controller apparatus and the operation times for selecting the analogue broadcasting channel, and since it is possible to select the digital broadcasting channel by pressing the digital broadcasting selection key and then selectively pressing the digit key included in the key matrix only when selecting the digital broadcasting channel, it is easy to select the analogue broadcasting channel or the digital broadcasting channel.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A remote controller apparatus, comprising:
a key input section including a menu key, a directional key, and a digit key for remotely controlling an image display device; and
a digital broadcasting channel selection key for being inputted prior to the digit key to select a digital broadcasting channel.

2. The apparatus as claimed in claim 1, wherein when selecting the digital broadcasting channel selection key and the digit key in order, the number of the digital broadcasting channel is selected.

3. The apparatus as claimed in claim 1, wherein after selecting the digital broadcasting channel selection key, the digital broadcasting channel is selected when an analogue channel number corresponding to the digital broadcasting channel is inputted through the digit key.

4. The apparatus as claimed in claim 3, wherein the analogue channel number is selected by the digit key corresponding to the analogue channel number.

5. A method for selecting a digital broadcasting channel by a remote controller apparatus, comprising steps of:
selecting a digital broadcasting channel selection key; and
selecting a digit key after the digital broadcasting channel selection key is selected.

6. The method as claimed in claim 5, wherein when selecting the digital broadcasting channel selection key and the digit key in order, the number of the digital broadcasting channel is selected.

7. The method as claimed in claim 5, wherein after selecting the digital broadcasting channel selection key, the digital broadcasting channel is selected when an analogue channel number corresponding to the digital broadcasting channel is inputted through the digit key.

8. The method as claimed in claim 7, wherein the analogue channel number is selected by the digit key corresponding to the analogue channel number.
